(19) United States
(12) Patent Application Publication
(10) Pub. No.: US 2010/0200251 A1
(43) Pub. Date: Aug. 12, 2010

(54) FITTED FIRE RESISTANT TENT WITH CLOSURES FOR CLOSE FIT RELATIONSHIP

(76) Inventors: Myra A. Garcia, Cerritos, CA (US); Eddie V. Garcia, Cerritos, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/368,043

(22) Filed: Feb. 9, 2009

(51) Int. Cl. A62C 8/00

(52) U.S. Cl. 169/49

(57) ABSTRACT

Fire resistant blanket to over fit a dwelling and be drawn into to close fit relationship therewith.

### BACKGROUND

1. Field of the Invention

The present invention relates to protective covering for protecting structures such as free standing homes, condominiums and mobile homes from fire.

2. Description of the Prior Art

The threat of home destruction by fire, and particularly fast moving large fires, is well known. Insurance coverage is available to protect against some of the damage rot by fire destruction of a dwelling but the significant loss of personal items, momentous, family albums, important documents and the loss of time and impact on the family psychology remains fully exposed.

Existing structures spread across the various communities and developments in populous and not so populous areas has rendered effective fire fighting nearly impossible task for protecting dwellings which may be constructed in close spaced relationship or in remote or inaccessible areas.

The problems are compounded in undulating terrains, and particularly those involving canyons and mountains where the most popular home sites are often high up on the ridges or atop the hill tops rendering them particularly vulnerable to fast moving fires moving up the canyon walls and often times leaving the houses inaccessible to ground fire fighting vehicles, even before considering the extent to which the fire fighting efforts are overtaxed.

Examples of the damage and loss of personal belongings which can result from such fires exist from the 2003 San Diego Calif. fire which spread over some 14,000 acres, the 1977 Montecito Calif. fire which consumed some 200 homes and the 2008 Sayr Calif. file which quickly spread to Sylmar and across the great extent of the San Fernando Valley destroying some 500 mobile homes.

Efforts have been made by individual homeowners to provide a deterrent to fast moving fires, as by cutting back vegetation such as trees and brush to leave a fire line around the home in effort to starve an oncoming fire from a fuel path to the dwelling. Other efforts have involved, for instance, high volume water pumps to withdrawal water from a water reservoirs such as a swimming pool or the like. Of course, the effectiveness of such deterrents depends on the extent to which the fire advances over great distances, possibly propelled by high winds or the like, and the relatively low volume of water in a residential pool and the fact that high temperatures quickly evaporate any water sprayed on the surface of the building thus soon leaving the surface of the dwelling dry and exposed to advancing flames or flying embers.

The task of protecting one's home are in various communities and outlining areas is compounded by the fact that at the very time the home needs protection, the local law enforcement agencies and fire departments enact a voluntary or involuntary evacuation thus removing the homeowner from the very venue where ongoing efforts are needed to protect the dwelling against, for instance, flying embers which may quickly ignite the combustible components of a dwelling.

Some of these remote and relatively inaccessible homes may benefit from water drops by fire fighting helicopters and fixed wing airplanes but the availability of that fire fighting equipment is extremely limited and the effectiveness dependent on the availability of water or chemical fire retardants and the quantity of drops made and accuracy of the pilots flying the aircraft.

In recognition of this danger of spreading fires and embers which may cause ignition, fire resistant structural components have been developed, such as shake and tile roofs and non combustible sidings but these advancements are no answer for the homeowner whose house does not incorporate those fire resistant materials and fails to provide any deterrent against embers and the like entering through air ventilation grills, chimney's and vents and other cracks and crevices that may allow for entry of high temperature combusting gases or embers.

As chronicled in the Los Angeles Times, Jan. 13, 2009 edition, fire chiefs are continuing to debate whether it is best for homeowner's in the urban or outlying areas to stay and defend their homes or to evacuate. As stated, fire fighting facilities do not have enough resources to put an engine at every house in harms way so homeowner's themselves must provide some of the defenses known today as merely garden hoses, water pumps and the like. Some communities are even providing classes to teach residents how to prepare their home to withstand flames as well as some rudimentary fire fighting skills. Of course, fire fighting experts have voiced concerns about the safety of those who elect to stay and fight. This is exacerbated by the fact that sudden fire storms may force rapid evacuation resulting last-minute exoduses, clogged streets and highways. Studies have shown that most civilians died while evacuating and most houses were lost from ember attacks that could have easily been extinguished. Up until this invention, homeowner's were faced with a dilemma of staying to fight with hoses and wet mops all with the risk of being forced to evacuate at the last minute. It is this need to which the present invention is directed.

### SUMMARY OF THE INVENTION

The present invention includes a fire resistant blanket of a size and shape to be deployed over the roof and sidewalls of a dwelling and to provide a skirt over the sidewalls to be drawn in tight about the lower extremity of the sidewalls to prevent entry of hot gases and hot embers. In one embodiment the blanket may be folded into a compac and stored in a closure anchored to the frame of the dwelling for ready access by the homeowner or family members.

### BRIEF DESCRIPTION OF THE DRAWINGS

FIG. 1 is a perspective view of a case housing the blanket of the present invention and anchored to a dwelling;

FIG. 2 is a vertical sectional view of the dwelling shown in FIG. 1;

FIG. 3 is a detail sectional view taken from the circle 3 in FIG. 2;

FIG. 4 is a perspective view similar to FIG. 1 but showing the case in its open position to expose the blanket folded in a pack, as well as personal storage boxes;

FIG. 5 is a personal storage boxes shown in FIG. 4;

FIG. 6 is a partial vertical sectional view, in enlarged scale, taken along the lines 6-6 of FIG. 5;

FIG. 7 is a perspective view of a house to be covered by the fire resistant cover device of the present invention;

FIG. 8 is a perspective view similar to FIG. 7 but showing the blanket of FIG. 4 in reduced scale and covering the house;

FIG. 9 is a perspective view similar to FIG. 8 but showing the closure device incorporated in the blanket of FIG. 4 and closing off the lower perimeter of the blanket;

FIG. 10 is perspective view similar to FIG. 9 but depicting the blanket with the take up devices actuated to take up excess material in the blanket;

FIG. 11 is a sectional view, in enlarged scale, taken along the line 11-11 of FIG. 8;

FIG. 12 is a detailed view, in enlarged scale, taken from the circle 12 in FIG. 8;

FIG. 13 is a view similar to FIG. 12 but showing the pick up device synched up; and

FIG. 14 is a sectional view taken along the line 14-14 of FIG. 13.

### DETAILED DESCRIPTION OF THE PREFERRED EMBODIMENTS

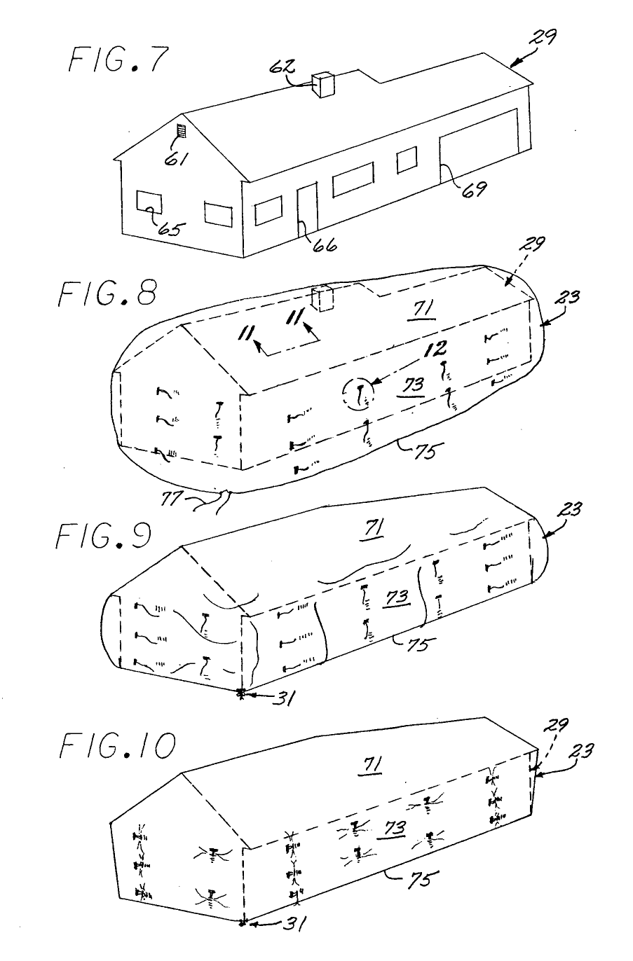

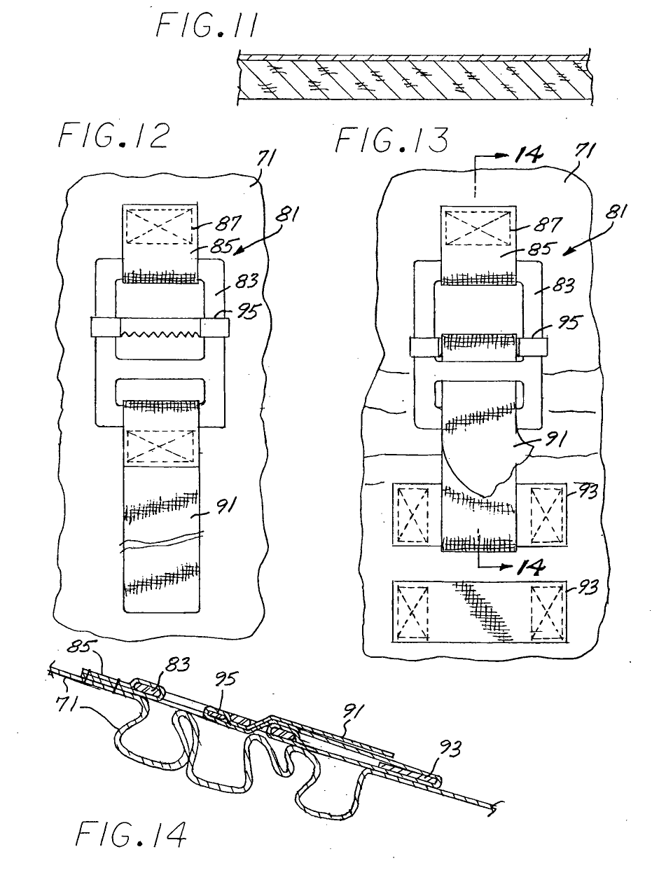

Referring to FIGS. 8-10, the fire protection covering device 21 of the present invention is in the form of a fire resistant blanket 23 which, when not in use, may be housed in a case 25 anchored to the frame of a dwelling 29 to be protected. The blanket is sized and configured to cover the entire top and sidewalls of the dwelling 29 as shown in FIG. 8 and includes a closure device, generally designated 31 in the bottom periphery thereof for synching up the lower periphery thereof about the dwelling 29 to protect against entry of hot gases and hot embers which might contact any combustible components of the dwelling 29.

Numerous different heat shields have been proposed for different applications, such as clothing for fire fighters and fire fighter shelters and often times include multiple layers cooperating in providing protection against convection of heat to the interior. It is contemplated that my blanket may include multiple layers to provide for water resistance, fire resistance, back drafts and the like. It is contemplated that the blanket may include layers of fiberglass textile, a low thermal conductivity blanket layer for further reduction of heat, a metal reflective exterior cover to reflect heat.

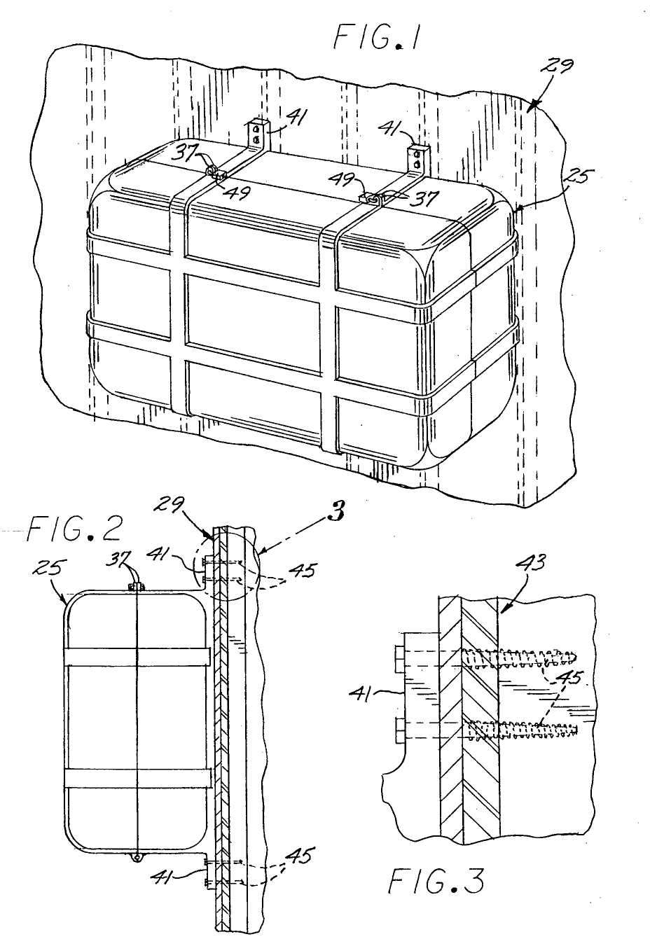

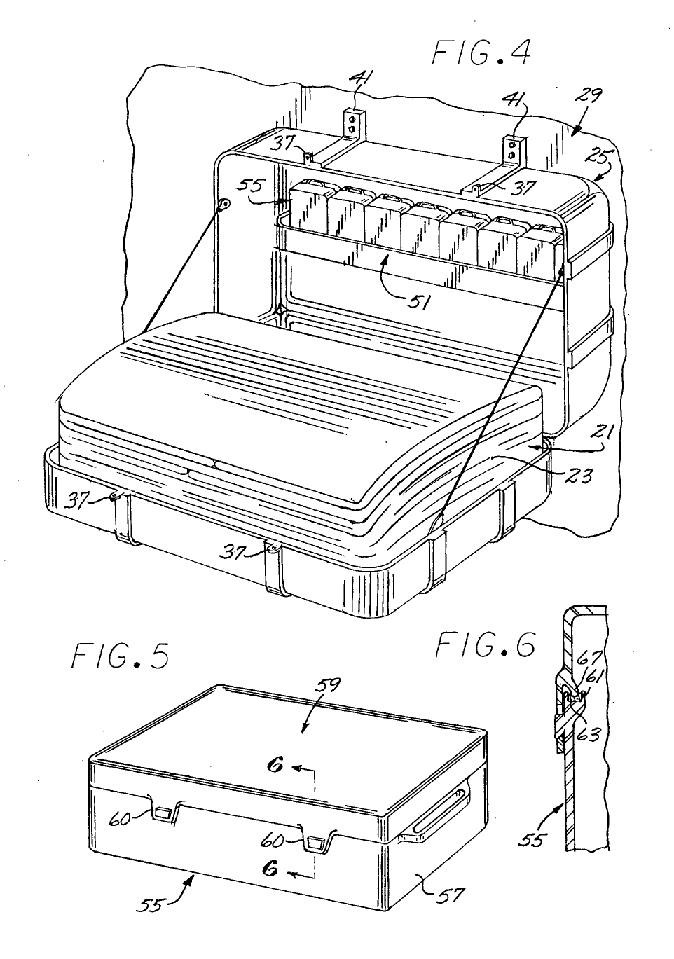

For our preferred embodiment, we have selected Nomex® with 100% aramid fiber and a weight of 60 to 250 grams per square meter, as manufactured by DuPont®, this fiber material enjoys the benefit that is inherently flame resistant, resists melting and combustion in the atmosphere and is moisture resistant to preserve its construction in the normal elements encountered in a fire threatened area. As will be recognized by those skilled in the art, the thickness and construction of the blanket may vary depending on a particular application and desires being important, that it have high flexibility and be abrasion resistant and favorable resistant to fire. In one embodiment it is constructed of a minimum of three and maximum of five layers of Nomex®, about ⅛^{th} inches thick. In other embodiments, the blanket is constructed of a fire resistant fabric coated with a fire resistant gel or of black slag which may be covered with a highly cylical yarn to provide an abrasion resistant coating. This material may have a weight have about 23 ounces per square yard with a plain weave and thickness of about 0.040 inches. The blanket itself is relatively thin, flexible and compact so it can be conveniently folded into a pack as shown in FIG. 4 which may be approximately 5 feet long 2½ feet wide and a foot to foot and a half deep as shown in FIG. 1. It is important that the blanket 23 be readily accessible in the event of an emergency and may be easily deployed by relatively inexperienced personnel. To this end, the container 25 may be constructed of fire resistant plastic having a high coefficient of thermal resistance and may be formed with anchor brackets 41 which may be lag screwed directly to the dwelling frame 43 by lag screws 45 as shown in FIGS. 2 and 3.

The container is hinged along one side and formed at the free edges of its body and cover with padlock ears 37 formed with respective through bores for receipt of the clasp of respective padlocks 49 (FIG. 1).

The body of the container 25 is configured in its upper rear extremity with a shelf, generally designated 51, for receipt of fire resistant personal saver boxes, generally designated 55, for receipt of individual items for each member of the household to thus provide for storage of important papers, photographs and documents which might be quickly retrieved when evacuating the house.

The personal boxes, which I refer to as “Intak-E-Boxes”, include fire resistant plastic bodies 57 having respective fire resistant covers 59 hingedly connected thereto and formed on their respective free extremities with closure clasps 60. The upper edge of the sidewalls of the respective box bodies 55 are formed with respective upwardly opening grooves 61 for receipt of respective fire resistant compressible seals 63 to be engaged by respective flanges 67 formed in the lower edges of the sidewalls of the cover 59 for sealing engagement thereof.

The blanket itself has constructed with sufficient size and configuration to cover the particular dwelling to be covered and itself is seamless and continuous throughout. As an example, a house 29 may be 150 feet long and 30 feet wide with a cathedral roof having a peak some 18 feet above the ground with air vents 61 and one or more chimney's 62. Such dwellings are often formed with window openings 65 pedestrian doors 66 and garage doors 69. It is an objective of my invention that the blanket cover the entire building, components thereof and be securely wrapped thereabout.

The blanket is constructed with a length width and height dimension which compliments the shape of the house 29 and they have a roof covering section 71 and side skirts 73 extending downwardly and terminating in lower extremities 75. The lower extremities may be formed with a turned back tunnel or the like to allow for a draw string style strap or rope 77 to be received therein so that the lower periphery of such skirts may be synched up in tight fit relationship about the bottom of the respective sidewalls of the house 29. As will be appreciated by those skilled in the art, the closure device 31 may take many different forms, such as the draw string style rope 77 or buckles or ties disposed about the periphery for securely drawing the skirt into place once the blanket is positioned on the building. The lower peripheries of the skirts may be formed with metal grommets to receive metal stakes to facilitate staking of the skirts in place.

In one preferred embodiment, the side skirts and, in some instances the top wall 71, have respective synching devices 81 spaced selectively throughout the exterior surface thereof. The synching devices include respective synching buckles 83 anchored to the surface of the blanket by means of fire resistant anchor straps 85 sewn in place by stitching 87.

Respective anchor belts 81 are secured to reinforcement straps 93 affixed to the blanket with the free extremities thereof threaded through respective synching bars 95 on the respective buckles for synching down the axis portions of the blankets sections to bring the blanket into close fit relationship about the periphery of the house 29 to further cooperate in evacuating air and its attendant oxygen from the area around the exterior of the house 29 to thereby cooperate in securing the blanket against separation from the dwelling under the forces of wind and attendant fire storm forces and to minimize the circulation of air and heat about the building.

In operation, the homeowner will acquire a blanket 23 having a dimension sufficient to cover the entire roof and walls of the house 29. The blanket is typically sold in a folded pack as shown in FIG. 4 ready for storage in a storage container 25 selected to receive the particular dimensions of the pack. The container 25 will be preferably be anchored to the foundation or frame studs of the dwelling as by lag screws 45 so that it will be always available in a known location.

The container 25 is typically formed with a locking device, such as the ears 37 for receipt of the padlocks 49 and/or combination locks or in some instances even a fracturable link hidden behind a breakable glass panel to be broken by a household member or possibly a fire fighter for quick access to the blanket 23. In some embodiments of the present invention, a instructional audio player is stored in the container 25 for ready access upon opening thereof, in some instances, is actuated by a electric switch coupled with the cover upon opening of the container so the instructional message is automatically played to remind the family members of the procedures to be followed i.e. instructions for the installation of the blanket 23, reminder of what individual personal objects are expected to be in the personal boxes 55 and what documents and items are to be retrieved and inserted in the boxes for each respective family member.

Typically, when there is a fire danger threatening a neighborhood the household, caretaker, manager or owner or the like will monitor the airways to determine the current state of the fire and, in some instances, the fire department will make contact by telephone or actually calling at the dwelling to advise of an approaching fire. It is anticipated that the warning will come hours or days in advance of the immediate threat to thus provide sufficient time for the family members to access the container 25 as by removing the padlocks 49 and opening the container to expose the blanket 23 and personal boxes 55. At that time the audio message will be delivered reminding the family members of the procedure to be followed and of any additional mementos, birth certificates, photographs or other important items which should be added to the respective personal boxes. In some instances the personal boxes will be removed to the vehicles intended to be utilized for transportation away from the area and but in some instances they may remain and after the blanket is removed the container 25 may be closed to facilitate preservation of any personal boxes that may be retained therein.

In any event, the blanket pack may be removed to the exterior of the home and have access to the roof, as by step ladder or the like. Typically a family member will carry the pack to the roof and unfold the blanket 23 to extend the peripheral skirt 73 downwardly over the eves of the roof while the roof section 71 covers the entire roof and chimney inlet. The family members on the ground might then cooperate in securing the lower edges 75 of the skirt 73 as by drawing up on the draw string rope 77 to tighten the lower periphery securely around the sidewalls at ground level as shown in FIG. 9. In some instances, other anchor components, such as weights or the like may be leaned against lower extremities of the skirt to assist in securement.

The family members may then move about the periphery of the building and grasp the respective pick up straps 91 to synch up the take up devices 81 to tighten down on the blanket to more closely conform to the periphery of the building to thus remove bulk and excessive forces of the blanket from bellowing out away from the walls of the dwelling thus tending to maintain a somewhat close fit relationship to cooperate in preventing the blanket from being blown away or the entrapment of oxygen baring air adjacent the dwelling walls to create a danger of thermal combustion from heat transfer through the blanket.

Once the blanket is secured in position, the family members are free to evacuate as directed by the authorities with a great degree of security that, even if neighboring homes should be inflamed, their dwelling will likely avoid combustion. In that regard, as hot flames or embers approach the dwelling 29, the embers will be deflected by the blanket and such blanket will create a thermal barrier against slowing transfer of heat to the dwelling thereby withstanding the initial onslaught of the fire and, in most instances, preventing any flammable components from the dwelling being raised to a combustible temperature of 200° F. or more to thereby protect the dwelling as the fire passes thereby.

Once the fire danger has passed, the family members may return and loosen the take up devices 81 and unfastened the draw string closure device to free the blanket to be withdrawn from the dwelling, cleaned, dried, folded and restored in the container 25.

From the foregoing, it will apparent that the fire resistant cover of the present invention provides inexpensive and secure protection against combustion as fires pass over a dwelling protected by a blanket of this invention. Such a device adds comfort and security to the homeowner and family members while, in many instances, likely contributing to lower premiums for fire insurance and, in some instances, even qualifying and otherwise unqualified dwelling for insurance.

We claim:

1. A fire resistant cover device for blanketing a flammable structure and comprising:
a flexible fire resistant blanket sized to fully enclose the exterior of the structure and having a skirt to cover the vertical walls thereof and terminating in a closure extremity follow the lower extremities of the respective vertical walls;
a closure device mounted to the closure extremity for drawing the closure extremity into close fit relationship with the lower extremities to block hot gasses and embers from direct contact with the structure.

2. The fire resistant cover of claim 1 that includes:
adjustment devices disposed in spaced apart relation about the surface of the blanket for drawing up on the blanket into close fitting relationship with the structure.

3. The fire resistant cover of claim 1 wherein:
the closure device includes draw strings to draw up on the extremity of the skirt.

4. The fire resistant cover device for covering a structure that includes a chimney and wherein:
the blanket is sized to extend over the roof of the house and the chimney.

5. The fire resistant cover device of claim 1 that included:
adjustment devices for drawing sections of the blanket together to draw it into close fitting relationship with the walls of the structure.

6. The fire resistant cover device of claim 1 for use with a structure that is a dwelling having house sections of different widths and wherein:
the blanket is constructed to fit over the house sections; and
the closure device is operable to draw the skirt into close fit relationship with the side walls of the house sections.

7. The cover device of claim 1 wherein:
the blanket is constructed to be, when not in use, folded into a pack of a predetermined configuration; and
that includes a container constructed to receive the pack.

8. The fire resistant cover device of claim 7 that includes:
an anchor device for anchoring the container to the structure.

9. The fire resistant cover device of claim 2 wherein;
the adjustment devices include straps anchored at distal ends in spaced relation and having proximal portions, and
buckles coupled with the respective proximal sections and operable to provide for the drawing of the proximal sections there through to lock their respective proximal sections drawn together.

10. Fire resistant apparatus for protecting a dwelling against combustion from surrounding fire and comprising:
a flexible foldable fire resistant and water repellant blanket sized and configured to entirely encase the exterior of the dwelling and, including side skirts for covering the sidewalls of the dwelling and having lower extremities cooperating to embrace the dwelling at the juncture between the sidewalls and ground surface;
a closure device attached to the lower extremity for drawing such lower extremity tightly around the dwelling;
the blanket being sufficiently flexible and of a thickness to be folded into a compact pack of a predetermined configuration;
a container anchored to the framework of the dwelling and including a compartment size to receive the pack.

11. The apparatus of claim 10 wherein:
the blanket device includes devices throughout the surface thereof and constructed to be tighten to synch down on the blanket and draw it into close spaced relationship with the exterior surface of the dwelling.

12. The apparatus of claim 10 wherein:
the blanket is constructed of Nomex®.

13. The apparatus of claim 10 that includes:
a audio recording in the compartment and operable to play audio instructions for use of the blanket.

14. A method of protecting a dwelling from on coming fire, including:
selecting a fire resistant blanket of a size and configuration to cover the roof and sidewalls of the dwelling;
placing the blanket on the dwelling;
actuating a closure device to draw the blanket into closed spaced relationship with the dwelling.

15. The method of claim 14 that includes:
selecting an audio player and recording video instructions to be followed in the use of the blanket.

16. The method of claim 14 that includes:
anchoring the container to the frame of the dwelling.
